(19) United States
(12) Patent Application Publication
(10) Pub. No.: US 2025/0132324 A1
(43) Pub. Date: Apr. 24, 2025

(54) POSITIVE ELECTRODE ACTIVE MATERIAL, LITHIUM-ION BATTERY, AND MANUFACTURING METHOD OF POSITIVE ELECTRODE ACTIVE MATERIAL

(71) Applicant: TOYOTA JIDOSHA KABUSHIKI KAISHA, Toyota-shi (JP)

(72) Inventor: So YUBUCHI, Shizuoka-ken (JP)

(73) Assignee: TOYOTA JIDOSHA KABUSHIKI KAISHA, Toyota-shi (JP)

(21) Appl. No.: 18/664,520

(22) Filed: May 15, 2024

(30) Foreign Application Priority Data
Oct. 20, 2023 (JP) 2023-181097

(51) Int. Cl. H01M 4/505; C01G 53/00; H01M 4/02; H01M 10/0525

(52) U.S. Cl. CPC H01M 4/505; C01G 53/50; H01M 10/0525; C01P 2002/50; C01P 2006/40; H01M 2004/028

(57) ABSTRACT

A positive electrode active material of this disclosure has an O2-type structure and an amount of carbon of 500 ppm or less. A manufacturing method of a positive electrode active material of this disclosure includes exchanging at least some of Na ions of a Na-containing oxide having a P2-type structure with Li ions to obtain a Li-containing oxide having an O2-type structure, and heating the Li-containing oxide to reduce an amount of carbon in the Li-containing oxide.

### CROSS-REFERENCE TO RELATED APPLICATION

This application claims priority to Japanese Patent Application No. 2023-181097 filed on Oct. 20, 2023, incorporated herein by reference in its entirety.

### BACKGROUND

### 1. Technical Field

This application discloses a positive electrode active material, a lithium-ion battery, and a manufacturing method of a positive electrode active material.

### 2. Description of Related Art

A positive electrode active material having an O2-type structure is known. As disclosed in Japanese Unexamined Patent Application Publication No. 2011-170994, a positive electrode active material having the O2-type structure is obtained by exchanging at least some of Na ions of a Na-containing oxide having a P2-type structure with Li ions.

### SUMMARY

The conventional positive electrode active material having the O2-type structure has room for improvement in terms of resistance.

This application discloses the following several aspects as means for solving this problem.

### <Aspect 1>

A positive electrode active material having an O2-type structure, wherein the positive electrode active material has an amount of carbon of 500 ppm or less.

### <Aspect 2>

The positive electrode active material of Aspect 1, wherein the positive electrode active material has an amount of sulfur of 300 ppm or less.

### <Aspect 3>

A lithium-ion battery, including a positive electrode active material layer, an electrolyte layer, and a negative electrode active material layer, wherein the positive electrode active material layer includes the positive electrode active material of Aspect 1 or 2.

### <Aspect 4>

A manufacturing method of a positive electrode active material, including:
exchanging at least some of Na ions of a Na-containing oxide having a P2-type structure with Li ions to obtain a Li-containing oxide having an O2-type structure; and
heating the Li-containing oxide to reduce an amount of carbon in the Li-containing oxide.

### <Aspect 5>

The manufacturing method of a positive electrode active material of Aspect 4, wherein:
an atmosphere in which the Li-containing oxide is heated is an inert gas atmosphere or an oxygen-containing atmosphere; and
a temperature at which the Li-containing oxide is heated is 200° C. or higher and 300° C. or lower.

### <Aspect 6>

The manufacturing method of a positive electrode active material of Aspect 4 or 5, wherein the Li-containing oxide is washed with water to reduce an amount of sulfur in the Li-containing oxide.

The positive electrode active material of this disclosure has the O2-type structure and has low resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows one example of a flow of a manufacturing method of a positive electrode active material having an O2-type structure;

FIG. 2 schematically shows a mechanism of how carbon is removed by heating; and

FIG. 3 schematically shows one example of the configuration of a lithium-ion battery.

### DETAILED DESCRIPTION OF EMBODIMENTS

One embodiment of a positive electrode active material, a lithium-ion battery, and a manufacturing method of a positive electrode active material of this disclosure will be described below. However, the positive electrode active material, the lithium-ion battery, and the manufacturing method of a positive electrode active material of this disclosure are not limited to the embodiment described below.

### 1. Positive Electrode Active Material

The positive electrode active material according to one embodiment has an O2-type structure and has an amount of carbon of 500 ppm or less.

### 1.1 Crystal Structure

The positive electrode active material according to one embodiment has at least an O2-type structure (which belongs to the space group P63mc) as the crystal structure. The positive electrode active material according to one embodiment may have the O2-type structure and also has a crystal structure other than the O2-type structure. Examples of crystal structures other than the O2-type structure include a T#2-type structure (which belongs to the space group Cmca) that is formed when Li is removed from and inserted into the O2-type structure, and an O6-type structure (which belongs to the space group R-3m, and has a c-axis length of 2.5 nm or longer and 3.5 nm or shorter, typically 2.9 nm or longer and 3.0 nm or shorter, and is different from an O3-type structure that also belongs to the space group R-3m). The positive electrode active material according to one embodiment may have the O2-type structure as a main phase. The positive electrode active material according to one embodiment may have the O2-type structure and one or both of the T#2-type structure and the O6-type structure. The positive electrode active material according to one embodiment can change in the crystal structure as the main phase according to its charging-discharging state.

### 1.2 Chemical Composition

The chemical composition of the positive electrode active material according to one embodiment is not particularly limited as long as the above-described O2-type structure can be maintained. The positive electrode active material having the O2-type structure may include at least, as constituent elements, at least one element among Mn, Ni, and Co, and Li and O. In particular, when the positive electrode active material includes at least Li, Mn, one or both of Ni and Co, and O as constituent elements, and particularly when the positive electrode active material includes at least Li, Mn, Ni, Co, and O as constituent elements, higher performance is likely to be achieved. The positive electrode active material according to one embodiment may have a chemical composition represented by LiₐNa_{b}Mnₓ₋ₚNi_{y-q}Co_{z-r}M_{p+q+r}O₂ (where 0<a<1.00, 0≤b≤0.20, x+y+2=1, and 0≤p+q+r<0.17 hold true, and the element M is at least one type selected from B, Mg, Al, K, Ca, Ti, V, Cr, Fe, Cu, Zn, Ga, Ge, Sr, Y, Zr, Nb, Mo, and W). When the positive electrode active material has such a chemical composition, the O2-type structure is likely to be maintained. In the above chemical composition, the number of a may be larger than 0, 0.10 or larger, 0.20 or larger, 0.30 or larger, 0.40 or larger, 0.50 or larger, or 0.60 or larger, and may be smaller than 1.00, 0.90 or smaller, 0.80 or smaller, or 0.70 or smaller. In the above chemical composition, the number of b may be 0 or larger, 0.01 or larger, 0.02 or larger, or 0.03 or larger, and may be 0.20 or smaller, 0.15 or smaller, or 0.10 or smaller. The number of x may be 0 or larger, 0.10 or larger, 0.20 or larger, 0.30 or larger, or 0.40 or larger, and may be 1.00 or smaller, 0.90 or smaller, 0.80 or smaller, 0.70 or smaller, 0.60 or smaller, 0.50 or smaller, or 0.40 or smaller. The number of y may be 0 or larger, 0.10 or larger, or 0.20 or larger, and may be 1.00 or smaller, 0.90 or smaller, 0.80 or smaller, 0.70 or smaller, 0.60 or smaller, 0.50 or smaller, 0.40 or smaller, 0.30 or smaller, or 0.20 or smaller. The number of z may be 0 or larger, 0.10 or larger, 0.20 or larger, 0.30 or larger, or 0.40 or larger, and may be 1.00 or smaller, 0.90 or smaller, 0.80 or smaller, 0.70 or smaller, 0.60 or smaller, 0.50 or smaller, or 0.40 or smaller. The element M contributes only a little to charging and discharging. In this respect, a high charging-discharging capacity is likely to be secured when the number of p+q+r is smaller than 0.17 in the above chemical composition. The number of p+q+r may be 0.16 or smaller, 0.15 or smaller, 0.14 or smaller, 0.13 or smaller, 0.12 or smaller, 0.11 or smaller, or 0.10 or smaller. On the other hand, when the element M is included, the O2-type structure is likely to stabilize. In the above chemical composition, the number of p+q+r may be 0 or larger, 0.01 or larger, 0.02 or larger, 0.03 or larger, 0.04 or larger, 0.05 or larger, 0.06 or larger, 0.07 or larger, 0.08 or larger, 0.09 or lager, or 0.10 or larger. While the number of the components of the O is almost 2, it is not limited to exact 2.0 and is indefinite.

### 1.3 Amount of Carbon

In a conventional positive electrode active material having the O2-type structure, lithium carbonate forms unavoidably due to its manufacturing process etc. Specifically, a positive electrode active material having the O2-type structure can be obtained by replacing (exchanging) Na ions of a Na-containing oxide having the P2-type structure with Li ions. Here, in the surface of the positive electrode active material after the ion exchange, Li or a Li compound that does not constitute the O2-type structure remains unavoidably. Further, the O2-type structure is a metastable phase, and Li or a Li compound can also form as part of the O2-type structure collapses. Such Li or a Li compound reacts with, for example, carbon dioxide originating from the atmosphere to turn into lithium carbonate. When the positive electrode active material having the O2-type structure includes a large amount of lithium carbonate, the resistance of the positive electrode active material becomes high.

By contrast, the positive electrode active material according to one embodiment has an amount of carbon of 500 ppm or less on a mass basis. Thus, compared with the conventional positive electrode active material, the positive electrode active material according to one embodiment has a significantly smaller amount of lithium carbonate that is an impurity. Accordingly, compared with the conventional positive electrode active material, the positive electrode active material according to one embodiment has lower resistance. The amount of carbon in the positive electrode active material according to one embodiment may be 400 ppm or less, 300 ppm or less, or 200 ppm or less. The lower limit of the amount of carbon is not particularly limited. The amount of carbon may be 0 ppm or more, 10 ppm or more, 50 ppm or more, 100 ppm or more, or 150 ppm or more. As will be described later, a positive electrode active material with such a small amount of carbon can be manufactured by heating (additionally firing) a Li-containing oxide resulting from the ion exchange.

The amount of carbon in the positive electrode active material can be measured by, for example, a combustion-infrared absorption method. As a measurement device, a carbon and sulfur analyzer (CS844 type) of LECO JAPAN CORPORATION is used.

### 1.4 Amount of Sulfur

The positive electrode active material according to one embodiment may have, in addition to the above-described amount of carbon, an amount of sulfur of 300 ppm or less on a mass basis. When the amount of sulfur in the positive electrode active material is reduced, the resistance in the positive electrode active material is likely to become even lower. The lower limit of the amount of sulfur is not particularly limited. The amount of sulfur may be 0 ppm or more, 10 ppm or more, 50 ppm or more, 100 ppm or more, 150 ppm or more, or 200 ppm or more. As will be described later, a positive electrode active material with such a small amount of sulfur can be manufactured by washing a Li-containing oxide resulting from the ion exchange with water.

The amount of sulfur in the positive electrode active material can be measured by, for example, a combustion-ion chromatograph method. As measurement devices, a sample combustion device (AQF-2100S) of Mitsubishi Chemical Analytech Co., Ltd. and an ion chromatograph (Compact IC Flex) of Metrohm Japan Ltd. are used.

### 1.5 Carbon-Sulfur Ratio

A mass ratio C/S between carbon and sulfur in the positive electrode active material according to one embodiment may be, for example, 0.70 or higher and 3.50 or lower, or 0.74 or higher and 3.46 or lower. When the mass ratio between carbon and sulfur in the positive electrode active material is within such a range, the positive electrode active material is likely to have a superior performance balance.

### 1.6 Shape

The positive electrode active material according to one embodiment can be obtained by replacing Na ions of a Na-containing oxide having the P2-type structure with Li ions. Here, the P2-type structure is a hexagonal system, in which the diffusion coefficient of Na ions is high and crystals tend to grow in a specific direction. In particular, when at least one of Mn, Ni, and Co is included as a transition metal element constituting part of the P2-type structure, crystals tend to grow in a specific direction into a plate shape. Therefore, a Na-containing oxide having the P2-type structure is usually plate-shaped particles having a high aspect ratio with the crystal growth direction biased toward a specific direction. The positive electrode active material according to one embodiment may be obtained based on such plate-shaped Na-containing oxide particles, or may be obtained based on spherical Na-containing oxide particles as will be described later. Thus, as to its shape, the positive electrode active material may be plate-shaped particles or may be spherical particles. When the positive electrode active material is spherical particles, as the crystallite size is reduced, the reaction resistance decreases, which is likely to lead to lower diffusion resistance inside the particles. Further, it is considered that when the positive electrode active material is applied to a battery, the tortuosity factor is reduced due to the spherical shape, leading to lower lithium-ion conduction resistance. As a result, for example, the rate characteristics are likely to improve, and the reversible capacity is likely to increase. In this application, a “spherical particle” means a particle of which the degree of circularity is 0.80 or higher. The degree of circularity of the particle may be 0.81 or higher, 0.82 or higher, 0.83 or higher, 0.84 or higher, 0.85 or higher, 0.86 or higher, 0.87 or higher, 0.88 or higher, 0.89 or higher, or 0.90 or higher. The degree of circularity of the particle is defined by 4πS/L². Here, S represents an orthographic projection area of the particle, and L represents a perimeter of an orthographic projection image of the particle. The degree of circularity of the particle can be obtained by observing the external appearance of the particle using a scanning electron microscope (SEM), a transmission electron microscope (TEM), or an optical microscope.

The positive electrode active material according to one embodiment may be, for example, solid particles, or may be hollow particles, or may be particles having voids. While the size of the positive electrode active material particles is not particularly limited, a smaller size is considered to be more advantageous. For example, an average particle diameter (D50) of the positive electrode active material particles may be 0.1 μm or larger and 10 μm or smaller, 1.0 μm or larger and 8.0 μm or smaller, or 2.0 μm or larger and 6.0 μm or smaller. The average particle diameter (D50) is a particle diameter at an integrated value 50% (D50, a median diameter) in a particle size distribution on a volume basis obtained by a laser diffraction-scattering method.

### 2. Manufacturing Method of Positive Electrode Active Material

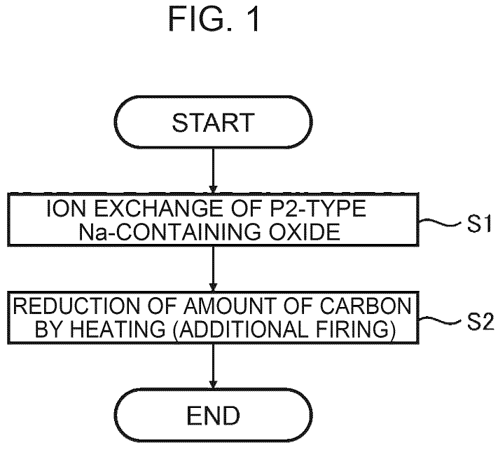

As shown in FIG. 1, the manufacturing method of a positive electrode active material according to one embodiment may include:
S1: Exchanging at least some of Na ions of a Na-containing oxide having the P2-type structure with Li ions to obtain a Li-containing oxide having the O2-type structure; and
S2: Heating the Li-containing oxide to reduce the amount of carbon in the Li-containing oxide.

### 2.1 S1

In S1, at least some of Na ions of a Na-containing oxide having the P2-type structure are exchanged with Li ions to obtain a Li-containing oxide having the O2-type structure.

### 2.1.1 Production of Na-Containing Oxide Having P2-Type Structure

The Na-containing oxide having the P2-type structure can be obtained by, for example, going through the following:
S1-1: Obtaining a precursor (e.g., a precursor including at least one element among Mn, Ni, and Co);
S1-2: Covering the surface of the precursor with a Na source to obtain a composite body; and
S1-3: Firing the composite body.

In S1-1, for example, a precursor including at least one element among Mn, Ni, and Co is obtained. The precursor may be one that includes at least Mn and one or both of Ni and Co, or may be one that includes at least Mn, Ni, and Co. The precursor may be salt including at least one element among Mn, Ni, and Co. For example, the precursor may be at least one type among carbonate, sulfate, nitrate, and acerate. Or the precursor may be a compound other than salt. For example, the precursor may be hydroxide. The precursor may be hydrate. The precursor may be a combination of a plurality of types of compounds. The precursor may have various shapes. For example, the precursor may have a particulate shape, or may be spherical particles as will be described later. The particle diameter of the particles formed by the precursor is not particularly limited. In S1-1, an ion source that can form a precipitate with transition metal ions in an aqueous solution, and a transition metal compound including at least one element among Mn, Ni, and Co may be used, and a precipitate as the above-described precursor may be obtained by a coprecipitation method. Thus, spherical particles as the precursor are likely to be obtained. The “ion source that can form a precipitate with transition metal ions in an aqueous solution” may be, for example, at least one type selected from sodium salt, such as sodium carbonate or sodium nitrate, sodium hydrate, and sodium oxide. The transition metal compound may be the aforementioned salt, hydroxide, etc. that includes at least one element among Mn, Ni, and Co. Specifically, in S1-1, a precipitate as the precursor may be obtained by turning each of the ion source and the transition metal compound into a solution, and dripping and mixing together these solutions. In this case, as a solvent, for example, water is used. In this case, as a base, various sodium compounds can be used, and an aqueous solution of ammonia etc. may be added to adjust the basicity. In the case of the coprecipitation method, a precipitate as the precursor can be obtained by, for example, preparing an aqueous solution of a transition metal compound and an aqueous solution of sodium carbonate and dripping and mixing together these aqueous solutions. Or it is also possible to obtain the precursor by a sol-gel method. In particular, the coprecipitation method is likely to be able to produce spherical particles as the precursor. In S1-1, the precursor may include an element M. The element M is at least one type selected from B, Mg, Al, K, Ca, Ti, V, Cr, Cu, Zn, Ga, Ge, Sr, Y, Zr, Nb, Mo, and W. These elements M function to, for example, stabilize the P2-type structure or the O2-type structure. The method of obtaining the precursor including the element M is not particularly limited. In the case where the precursor is obtained by the coprecipitation method in S1-1, the precursor including the element M in addition to at least one element among Mn, Ni, and Co can be obtained by, for example, preparing an aqueous solution of a transition metal compound including at least one of Mn, Ni, and Co, an aqueous solution of sodium carbonate, and an aqueous solution of a compound of the element M, and dripping and mixing together these aqueous solutions. Or in the manufacturing method of this disclosure, without the element M being add in S1-1, the element M may be doped when Na doping firing is performed in S1-2 and S1-3 to be described later.

In S1-2, the surface of the precursor obtained by S1-1 is covered with a Na source to obtain a composite body. The Na source may be salt including Na, such as carbonate or nitrate, or may be a compound other than salt, such as sodium oxide or sodium hydroxide. In S1-2, the amount of the Na source to cover the surface of the precursor can be determined taking into account an amount of Na that is lost during firing afterward. In S1-2, a coverage ratio of the Na source on the surface of the precursor is not particularly limited. For example, in S1-2, the above-described composite body may be obtained by covering the surface of the above-described precursor with the Na source to 40 area % or more, 50 area % or more, 60 area % or more, or 70 area % or more. Here, in the case where the precursor obtained by S1-1 is spherical particles and the composite body obtained by S1-2 is obtained by covering the surface of the above-described precursor with the above-described Na source to 40 area % or more, the Na-containing oxide having the P2-type structure is likely to become spherical particles in S1-3 to be described later. If the coverage ratio of the Na source is low, when the composite body is fired, the P2-type crystals are likely to grow in the surface of the composite body and the Na-containing oxide is likely to assume a plate shape. If the coverage ratio of the Na source is high, when the composite body is fired, crystallites of the P2-type crystals are likely to become small, as well as the Na-containing oxide is likely to become spherical particles corresponding to the shape of the precursor. In S1-2, the method of covering the surface of the above-described precursor with the Na source is not particularly limited. In the case where the surface of the precursor is covered with the Na source to 40 area % or more as described above, various methods can be named as the method to do so. Examples include a rolling fluidized coating method and a spray drying method. Specifically, a coating solution in which the Na source has been dissolved is prepared, and the surface of the precursor is brought into contact with the coating solution, and at the same time with or after that, the precursor is dried. The surface of the precursor can be covered with the Na source to 40 area % or more by adjusting the coating conditions (temperature, time, number of times, etc.). In S1-2, the precursor may be covered with an M source in addition to the Na source. For example, in S1-2, the composite body may be obtained by mixing together the precursor obtained by S1-1, the Na source, and the M source including at least one type of element M selected from B, Mg, Al, K, Ca, Ti, V, Cr, Cu, Zn, Ga, Ge, Sr, Y, Zr, Nb, Mo, and W. The M source may be, for example, salt including the element M, such as carbonate or nitrate, or may be a compound other than salt, such as oxide or hydroxide. The amount of the M source relative to the precursor can be determined according to the chemical composition of the Na-containing oxide after firing.

In S1-3, the composite body obtained by S1-2 is fired to obtain a Na-containing oxide having the P2-type structure. S1-3 includes, for example, the following S1-3A, S1-3B, and S1-3C.

In S1-3A, the above-described composite body is subjected to preliminary firing at a temperature of 300° C. or higher and lower than 700° C. for two hours or longer and ten hours or shorter. In S1-3A, the preliminary firing may be performed after the above-described composite body is arbitrarily shaped. The preliminary firing is performed at a temperature lower than that of main firing. If the preliminary firing in S1-3A is insufficient, formation of a P2 phase may become insufficient in the Na-containing oxide that is finally obtained. In S1-3A, when the preliminary firing temperature is 300° C. or higher and lower than 700° C. and the preliminary firing time is two hours or longer and ten hours or shorter, sufficient preliminary firing can be performed on the composite body, so that thermal uniformity is enhanced, and the Na-containing oxide obtained by going through S1-3B and S1-3C, to be described later, is likely to become an appropriate one. The preliminary firing temperature may be 400° C. or higher and lower than 700° C., 450° C. or higher and lower than 700° C., 500° C. or higher and lower than 700° C., 550° C. or higher and lower than 700° C., or 550° C. or higher and 650° C. or lower. The preliminary firing time may be two hours or longer and eight hours or shorter, three hours or longer and eight hours or shorter, four hours or longer and eight hours or shorter, five hours or longer and eight hours or shorter, or five hours or longer and seven hours or shorter. The preliminary firing atmosphere is not particularly limited, and may be, for example, an oxygen-containing atmosphere.

In S1-3B, continuously from the above-described preliminary firing, the above-described composite body is subjected to the main firing at a temperature of 700° C. or higher and 1100° C. or lower for 30 minutes or longer and ten hours or shorter. In S1-3B, the main firing temperature of the composite body is 700° C. or higher and 1100° C. or lower, preferably 800° C. or higher and 1000° C. or lower. If the main firing temperature is too low, the P2 phase does not form, and if the main firing temperature is too high, an 03 phase etc. instead of the P2 phase is likely to form. The temperature raising condition from the preliminary firing temperature to the main firing temperature is not particularly limited. The main firing time is not particularly limited and may be, for example, 30 minutes or longer and 48 hours or shorter. However, the shape of the Na-containing oxide can be controlled by the main firing time. In the method of this disclosure, in the case where the coverage ratio of the Na source on the composite body is 40 area % or more as described above, P2-type crystals with small crystallites are likely to form in the surface of the composite body when it is fired. In the method of this disclosure, the P2-type crystals are grown along the surfaces of the particles such that one P2-type crystallite and another P2-type crystallite are coupled to each other, and thus the shape of the Na-containing oxide becomes a shape corresponding to the shape of the precursor. For example, when the precursor is spherical particles, the Na-containing oxide can also become spherical particles. If the main firing time is too short, the formation of the P2 phase becomes insufficient. On the other hand, if the main firing time is too long, the P2-phase grows excessively, and the particles assume a plate shape instead of a spherical shape. As far as the present inventor has confirmed, when the main firing time is 30 minutes or longer and three hours or shorter, spherical particles of the Na-containing oxide are likely to be obtained. The Na-containing oxide resulting from the main firing may have a plurality of crystallites present in the surface and have a structure with the crystallites coupled to one another.

In S1-3C, continuously from the above-described main firing, the above-described composite body is subjected to rapid cooling from a temperature T₁ of 200° C. or higher to a temperature T₂ of 100° C. or lower (temperature decrease speed: 20° C./min or higher). The above-described preliminary firing and main firing are performed, for example, inside a heating furnace. In step S3-3, for example, after the main firing of the composite body is performed inside a heating furnace, the composite body is cooled to an arbitrary temperature T₁ of 200° C. or higher inside the heating furnace, and after this temperature T₁ is reached, the fired product is taken out of the heating furnace and subjected to rapid cooling to an arbitrary temperature T₂ of 100° C. or lower outside the furnace. The temperature T₁ is an arbitrary temperature of 200° C. or higher, and may be an arbitrary temperature of 250° C. or higher. The temperature T₂ is an arbitrary temperature of 100° C. or lower, and may be an arbitrary temperature of 50° C. or lower, or may be a cooling end temperature. In a predetermined temperature range from the temperature T₁ to the temperature T₂, moisture is likely to enter between layers of the P2-type structure due to atomic vibration, molecular motion, etc. When cooling the composite body after the main firing (the Na-containing oxide having the P2-type structure), shortening the time of remaining in such a temperature range in which moisture is likely to enter (i.e., performing rapid cooling) can presumably reduce the amount of entry of moisture between the layers of the P2-type structure. In this respect, in step S3-3, when cooling the composite body after the main firing, the composite body is let cool from the arbitrary temperature T₁ of 200° C. or higher to the arbitrary temperature T₂ of 100° C. or lower, for example, in a dry atmosphere outside the furnace. Thus, the cooling speed from the temperature T₁ to the temperature T₂ becomes high (e.g., 20° C./min or higher), so that moisture is less likely to enter between the layers of the P2-type structure, and collapse of the P2-type structure etc. can be mitigated. As a result, in S4, Na ions can be efficiently exchanged with Li ions.

As has been described above, by S1-1 to S1-3, the Na-containing oxide having the P2-type structure and having a predetermined chemical composition can be manufactured. The Na-containing oxide includes at least, as constituent elements, at least one transition metal element among Mn, Ni, and Co, and Na and O. In particular, when at least Na, Mn, at least either Ni or Co, and O are included as constituent elements, particularly when at least Na, Mn, Ni, Co, and O are included as constituent elements, the performance of the positive electrode active material is likely to become even more higher. The Na-containing oxide may have a chemical composition represented by Na_{c}Mnₓ₋ₚNi_{y-q}CO_{z-r}M_{p+q+r}O₂. Here, 0<c<1.00, x+y+z=1, and 0≤p+q+r<0.17 hold true. M is at least one type of element selected from B, Mg, Al, K, Ca, Ti, V, Cr, Fe, Cu, Zn, Ga, Ge, Sr, Y, Zr, Nb, Mo, and W. When the Na-containing oxide has such a chemical composition, the P2-type structure is likely to be further maintained. In the above chemical composition, the number of c may be larger than 0, 0.10 or larger, 0.20 or larger, 0.30 or larger, 0.40 or larger, 0.50 or larger, or 0.60 or larger, and may be smaller than 1.00, 0.90 or smaller, 0.80 or smaller, or 0.70 or smaller. The number of x may be 0 or larger, 0.10 or larger, 0.20 or larger, 0.30 or larger, or 0.40 or larger, and may be 1.00 or smaller, 0.90 or smaller, 0.80 or smaller, 0.70 or smaller, 0.60 or smaller, 0.50 or smaller, or 0.40 or smaller. The number of y may be 0 or larger, 0.10 or larger, or 0.20 or larger, and may be 1.00 or smaller, 0.90 or smaller, 0.80 or smaller, 0.70 or smaller, 0.60 or smaller, 0.50 or smaller, 0.40 or smaller, 0.30 or smaller, or 0.20 or smaller. The number of z may be 0 or larger, 0.10 or larger, 0.20 or larger, 0.30 or larger, or 0.40 or larger, and may be 1.00 or smaller, 0.90 or smaller, 0.80 or smaller, 0.70 or smaller, 0.60 or smaller, 0.50 or smaller, or 0.40 or smaller. The element M contributes only a little to charging and discharging. In this respect, when the number of p+q+r is smaller than 0.17 in the above chemical composition, a high charging-discharging capacity is likely to be secured. The number of p+q+r may be 0.16 or smaller, 0.15 or smaller, 0.14 or smaller, 0.13 or smaller, 0.12 or smaller, 0.11 or smaller, or 0.10 or smaller. On the other hand, when the element M is included, the P2-type structure or the O2-type structure is likely to stabilize. In the above chemical composition, the number of p+q+r may be 0 or larger, 0.01 or larger, 0.02 or larger, 0.03 or larger, 0.04 or larger, 0.05 or larger, 0.06 or larger, 0.07 or larger, 0.08 or larger, 0.09 or lager, or 0.10 or larger. While the number of the components of O is almost 2, it is not limited to exact 2.0 and is indefinite.

### 2.1.2 Ion Exchange

In S1, at least some of Na ions of the Na-containing oxide obtained as described above are exchanged with Li ions to obtain a Li-containing oxide having the O2-type structure. For the ion exchange, for example, there is a method that uses an aqueous solution including lithium halide, and a method that uses a mixture of lithium halide and another lithium salt (e.g., molten salt). From the viewpoint that the P2-type structure is prone to collapse due to entry of water and the viewpoint of crystallizability, of these two methods, the method using molten salt is preferable. Specifically, at least some of Na ions of the Na-containing oxide can be replaced with Li ions by ion exchange, by mixing the above-described Na-containing oxide having the P2-type structure and the molten salt together and heating the mixture to a temperature equal to or higher than the melting point of the molten salt. It is preferable that the lithium halide constituting part of the molten salt be at least one of lithium chloride, lithium bromide, and lithium iodide. It is preferable that the other lithium salt constituting part of the molten salt be lithium nitrate. When molten salt is used, the melting point becomes lower than when lithium halide or other lithium salt is used alone, which allows ion exchange at a lower temperature. The temperature during the ion exchange may be, for example, equal to or higher than the melting point of the above-described molten salt, and may be 600° C. or lower, 500° C. or lower, 400° C. or lower, or 300° C. or lower. If the temperature during the ion exchange is too high, instead of the O2-type structure, the O3-type structure that is a stable phase is likely to form. On the other hand, from the viewpoint of shortening the time taken for the ion exchange, the higher the temperature during the ion exchange, the better.

### 2.2 S2

In S2, the Li-containing oxide obtained by S1 is heated to reduce the amount of carbon in the Li-containing oxide. Specifically, the Li-containing oxide having the O2-type structure resulting from the ion exchange is subjected to additional firing to remove at least part of carbon (lithium carbonate) present in the surface etc. of the Li-containing oxide.

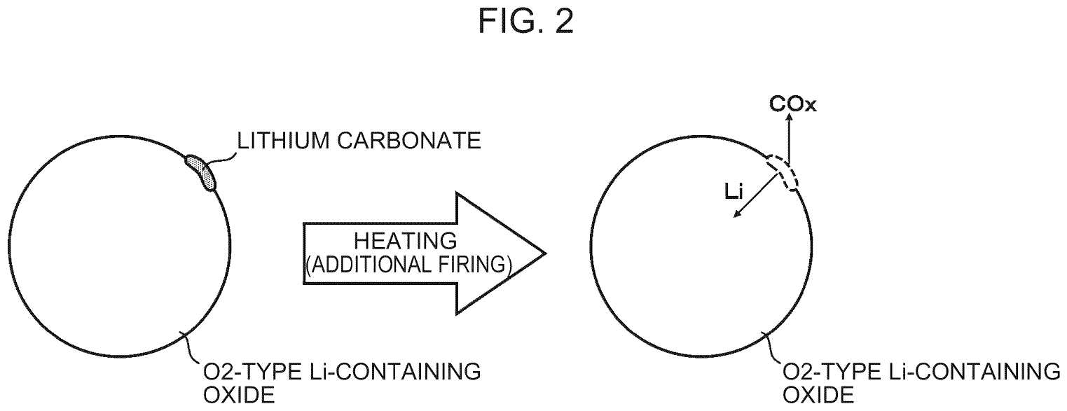

The Li-containing oxide having the O2-type structure assumes a Li-deficient crystal structure. Specifically, in the positive electrode active material having the O2-type structure, the composition ratio Li/O between Li and O is lower than 0.5 (e.g., “a” in the above-described composition formula is smaller than 1.0), and there is room for inserting Li into the crystal structure. It is considered that when such a Li-deficient Li-containing oxide is heated, as shown in FIG. 2, the lithium carbonate in the surface of the Li-containing oxide is separated into Li and COₓ, and Li is taken into the crystal structure, while COₓ is removed to the outside of the Li-containing oxide. Thus, when the Li-containing oxide having the O2-type structure resulting from the ion exchange is subjected to additional firing, at least part of the carbon (lithium carbonate) present in the surface etc. of the Li-containing oxide is removed, and the amount of carbon in the positive electrode active material that is finally obtained becomes 500 ppm or less. Such action and effect are peculiar to the case where a Li-containing oxide having the O2-type structure is heated.

In S2, the atmosphere in which the Li-containing oxide is heated may be any atmosphere such that the O2-type structure of the Li-containing oxide is maintained and that, moreover, the amount of carbon in the Li-containing oxide can be reduced. For example, the heating atmosphere may be an inert gas atmosphere, such as an Ar atmosphere, or an oxygen-containing atmosphere, such as an ambient air atmosphere.

In S2, the temperature at which the Li-containing oxide is heated may be any temperature such that the O2-type structure of the Li-containing oxide is maintained and that, moreover, the amount of carbon in the Li-containing oxide can be reduced. If the temperature is too low, the above-described carbon removing reaction is less likely to occur. On the other hand, if the temperature is too high, the O2-type structure that is a metastable phase is likely to change into the O3-type structure that is a stable phase. From the viewpoint of appropriately removing carbon while maintaining the O2-type structure, the temperature in S2 may be, for example, 200° C. or higher and 300° C. or lower. This temperature may be 220° C. or higher or 240° C. or higher, and may be 280° C. or lower or 260° C. or lower.

In S2, the time for which the Li-containing oxide is heated may be any time such that the O2-type structure of the Li-containing oxide is maintained and that, moreover, the amount of carbon in the Li-containing oxide can be reduced. The time in S2 (the holding time at the above-described heating temperature) may be, for example, 30 minutes or longer and ten hours or shorter, two hours or longer and eight hours or shorter, or four hours or longer and six hours or shorter.

### 2.3 Other Steps

According to the above-described method including S1 and S2, a positive electrode active material having the O2-type structure and having an amount of carbon of 500 ppm or less can be manufactured. The manufacturing method of the positive electrode active material according to one embodiment may include washing the Li-containing oxide obtained by S1 with water to reduce the amount of sulfur in the Li-containing oxide. Water washing of the Li-containing oxide may be performed before the above-described S2, or may be performed after the above-described S2. In particular, performing water washing before the above-described S2 and then performing S2 can presumably reduce the amount of moisture in addition to the amount of carbon and the amount of sulfur in the positive electrode active material. As a result of performing water washing of the Li-containing oxide, the amount of sulfur in the positive electrode active material that is finally obtained becomes 300 ppm. While water washing of the Li-containing oxide is effective for reducing the amount of sulfur in the positive electrode active material that is finally obtained, it is virtually ineffective in reducing the amount of carbon. To reduce the amount of carbon in the positive electrode active material that is finally obtained, for example, additional firing as described above is required.

### 3. Lithium-Ion Battery

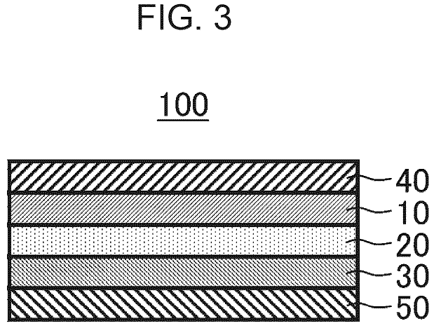

FIG. 3 schematically shows the configuration of the lithium-ion battery according to one embodiment. As shown in FIG. 3, a lithium-ion battery 100 according to one embodiment has a positive electrode active material layer 10, an electrolyte layer 20, and a negative electrode active material layer 30. Here, the positive electrode active material layer 10 includes the positive electrode active material according to the above-described embodiment. As shown in FIG. 3, the lithium-ion battery 100 can include a positive electrode current collector 40 and a negative electrode current collector 50.

### 3.1 Positive Electrode Active Material Layer

The positive electrode active material layer 10 includes the above-described positive electrode active material having the O2-type structure. The positive electrode active material layer 10 may optionally include another positive electrode active material, an electrolyte, a conduction agent, a binder, etc. In addition, the positive electrode active material 10 may include various additives. The content of each of the positive electrode active material, the electrolyte, the conduction agent, the binder, etc. in the positive electrode active material layer 10 can be determined as appropriate according to the intended battery performance. For example, with an entire solid content in the positive electrode active material layer 10 as 100 mass %, the content of the positive electrode active material may be 40 mass % or higher and 100 mass % or lower.

On the surface of the positive electrode active material, an ion-conducting protective layer may be formed. Specifically, the positive electrode active material layer 10 may include a composite body of the positive electrode active material and the protective layer, or in this composite body, at least part of the surface of the positive electrode active material may be covered with the protective layer. The ion-conducting protective layer can include various ion-conducting compounds. The ion-conducting compound may be, for example, at least one type selected from an ion-conducting oxide, an ion-conducting halide, etc. The coverage ratio (area ratio) of the protective layer on the surface of the positive electrode active material may be, for example, 70% or higher, or may be 80% or higher, or may be 90% or higher. The thickness of the protective layer may be, for example, 0.1 nm or larger or 1 nm or larger, and may be 100 nm or smaller or 20 nm or smaller.

The positive electrode active material included in the positive electrode active material layer 10 may be composed only of the above-described positive electrode active material having the O2-type structure, or may include, in addition to this positive electrode active material, a positive electrode active material other than that (another positive electrode active material). From the viewpoint of further enhancing the effect of the technology of this disclosure, the ratio of the other positive electrode active material in the entire positive electrode active material may be low. For example, with the entire positive electrode active material as 100 mass %, the content of the above-described positive electrode active material having the O2-type structure may be 50 mass % or higher and 100 mass % or lower, 60 mass % or higher and 100 mass % or lower, 70 mass % or higher and 100 mass % or lower, 80 mass % or higher and 100 mass % or lower, 90 mass % or higher and 100 mass % or lower, 95 mass % or higher and 100 mass % or lower, or 99 mass % or higher and 100 mass % or lower.

The electrolyte that can be included in the positive electrode active material layer 10 may be a solid electrolyte, or may be a liquid electrolyte, or may be a combination of the two. In particular, when the positive electrode active material layer 10 includes a solid electrolyte, particularly a sulfide solid electrolyte, high performance is likely to be secured. The sulfide solid electrolyte may be a glass-based sulfide solid electrolyte (sulfide glass), or may be a glass ceramic-based sulfide solid electrolyte, or may be a crystal-based sulfide solid electrolyte. The sulfide glass is amorphous. The sulfide glass may have a glass transition temperature (Tg). When the sulfide solid electrolyte has a crystal phase, examples of the crystal phase include a Thio-LISICON-type crystal phase, an LGPS-type crystal phase, and an argyrodite crystal phase. The sulfide solid electrolyte can contain, for example, a Li element, a P element, and a S element. The sulfide solid electrolyte may further contain an X element (X is at least one type among As, Sb, Si, Ge, Sn, B, Al, Ga, and In). The sulfide solid electrolyte may further contain at least either an O element or a halogen element. The sulfide solid electrolyte may contain a S element as a main component of an anion element. The sulfide solid electrolyte may be at least one type selected from, for example, Li_{z}S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂—P₂S₅—LiI, Li₂S—P₂S₅—ZmSn (where m and n are positive numbers; Z is one of Ge, Zn, and Ga), Li₂S—SiS₂—Li₃PO₄, and Li₂S—SiS₂—LiₓMO_{y} (where x and y are positive numbers; M is P and optionally one of Si, Ge, B, Al, Ga, and In). Or, while not particularly limited, the sulfide solid electrolyte may have at least one chemical composition selected from, for example, xLi₂S·(100−x)P₂S₅ (70≤x≤80), yLiI·zLiBr·(100−y−z)(xLi₂S·(1−x)P₂S₅) (0.7≤x≤0.8, 0≤y≤30, 0≤z≤30), etc. Or the sulfide solid electrolyte may have a chemical composition represented by a general formula: Li₄₋ₓGe₁₋ₓPₓS₄ (0<x<1). In this general formula, at least part of Ge may be substituted with at least one of Sb, Si, Sn, B, Al, Ga, In, Ti, Zr, V, and Nb. In this general formula, at least part of P may be substituted with at least one of Sb, Si, Sn, B, Al, Ga, In, Ti, Zr, V, and Nb. In this general formula, part of Li may be substituted with at least one of Na, K, Mg, Ca, and Zn. In this general formula, part of S may be substituted with halogen (at least one of F, Cl, Br, and I). Or the sulfide solid electrolyte may have a chemical composition represented by Li₇₋ₐPS₆₋ₐXₐ (X is at least one type among Cl, Br, and I, and a is a number that is 0 or larger and 2 or smaller). The number of a may be 0 or may be larger than 0. In the latter case, the number of a may be 0.1 or larger, or may be 0.5 or larger, or may be 1 or larger. The number of a may be 1.8 or smaller or may be 1.5 or smaller. The sulfide solid electrolyte may have a particulate shape. An average particle diameter (D50) of the sulfide solid electrolyte may be, for example, 10 nm or larger and 100 μm or smaller.

Examples of the conduction agent that can be included in the positive electrode active material layer 10 include carbon materials, such as vapor-grown carbon fiber (VGCF), acetylene black (AB), ketjen black, carbon nanotube (CNT), and carbon nanofiber (CNF), and metal materials, such as nickel, titanium, aluminum, and stainless steel. The conduction agent may have, for example, a particulate shape or a fiber shape, and the size thereof is not particularly limited. Only one type of conduction agent may be used alone, or two or more types may be used in combination.

Examples of the binder that can be included in the positive electrode active material layer 10 include a butadiene rubber (BR)-based binder, a butylene rubber (IIR)-based binder, an acrylate-butadiene rubber (ABR)-based binder, a styrene-butadiene rubber (SBR)-based binder, a polyvinylidene fluoride (PVdF)-based binder, a polytetrafluoroethylene (PTFE)-based binder, and a polyimide (PI)-based binder. Only one type of binder may be used alone, or two or more types may be used in combination.

Other than the above-described ingredients, the positive electrode active material layer 10 may include various additives. Examples are a dispersant and a lubricant.

### 3.2 Electrolyte Layer

The electrolyte layer 20 is disposed between the positive electrode active material layer 10 and the negative electrode active material layer 30. The electrolyte layer 20 includes at least an electrolyte. The electrolyte layer 20 may include at least either a solid electrolyte or a liquid electrolyte, and may further optionally include a binder etc. In particular, when the electrolyte layer 20 includes a solid electrolyte, particularly when the electrolyte layer 20 includes a sulfide solid electrolyte, higher performance is likely to be secured. The contents of the electrolyte, the binder, etc. in the electrolyte layer 20 are not particularly limited. Or the electrolyte layer 20 may have a separator or the like for holding an electrolytic solution and preventing contact with the positive electrode active material layer 10 and the negative electrode active material layer 30. The thickness of the electrolyte layer 20 is not particularly limited, and may be, for example, 0.1 μm or larger or 1 μm or larger, and may be 2 mm or smaller or 1 mm or smaller.

The electrolyte that is included in the electrolyte layer 20 can be selected as appropriate from the electrolytes (the solid electrolytes and/or the liquid electrolytes) that were given as examples of the electrolyte that can be included in the positive electrode active material layer 10. The binder that can be included in the electrolyte layer 20 can also be selected as appropriate from the binders that were given as examples of the binder that can be included in the above-described positive electrode active material layer. One type each of the electrolyte and the binder may be used alone, or two or more types may be used in combination. The separator may be any separator that is usually used in lithium-ion batteries, and examples include those made of resin, such as polyethylene (PE), polypropylene (PP), polyester, or polyamide. The separator may have a single-layer structure or may have a multi-layer structure. Examples of the separator with a multi-layer structure include a separator with a PE/PP double-layer structure, and a separator with a PP/PE/PP or PE/PP/PE three-layer structure. The separator may be one formed by non-woven fabric, such as cellulose non-woven fabric, resin non-woven fabric, or glass fiber non-woven fabric.

### 3.3 Negative Electrode Active Material Layer

The negative electrode active material layer 30 includes at least a negative electrode active material. The negative electrode active material layer 30 may optionally include an electrolyte, a conduction agent, a binder, various additives, etc. The content of each ingredient in the negative electrode active material layer 30 can be determined as appropriate according to the intended battery performance. For example, with an entire solid content in the negative electrode active material layer 30 as 100 mass %, the content of the negative electrode active material may be 40 mass % or higher, 50 mass % or higher, 60 mass % or higher, or 70 mass % or higher, and may be 100 mass % or lower, lower than 100 mass %, 95 mass % or lower, or 90 mass % or lower. Or with the entire negative electrode active material layer 30 as 100 vol %, the negative electrode active material, and optionally an electrolyte, a conduction agent, and a binder may be contained 85 vol % or more, 90 vol % or more, or 95 vol % or more in total, and the rest may be voids or other ingredients. The shape of the negative electrode active material layer 30 is not particularly limited, and may be, for example, a sheet shape having a substantially planar surface. The thickness of the negative electrode active material layer 30 is not particularly limited, and may be, for example, 0.1 μm or larger, 1 μm or larger, 10 μm or larger, or 30 μm or larger, and may be 2 mm or smaller, 1 mm or smaller, 500 μm or smaller, or 100 μm or smaller.

For the negative electrode active material included in the negative electrode active material layer 30, any active material that is commonly known as a negative electrode active material for lithium-ion batteries can be adopted. Of commonly known active materials, various materials of which the potential for storing and releasing lithium ions (charging-discharging potential) is a less-noble potential compared with that of the above-described positive electrode active material can be adopted. For example, silicon-based active materials, such as Si, Si alloy, and silicon oxide; carbon-based active materials, such as graphite and hard carbon; various oxide-based active materials, such as lithium titanate; and metallic lithium and lithium alloy can be adopted. In particular, when the negative electrode active material layer 30 includes Si as a negative electrode active material, the performance of the lithium-ion battery 100 is likely to be enhanced. Only one type of negative electrode active material may be used alone, or two or more types may be used in combination. The shape of the negative electrode active material may be any shape that is a common shape for negative electrode active materials of lithium-ion batteries. For example, the negative electrode active material may have a particulate shape. The negative electrode active material particles may be primary particles, or may be secondary particles into which a plurality of primary particles has aggregated. An average particle diameter (D50) of the negative electrode active material particles may be, for example, 1 nm or larger, 5 nm or larger, or 10 nm or larger, or may be 500 μm or smaller, 100 μm or smaller, 50 μm or smaller, or 30 μm or smaller. Or the negative electrode active material may have a sheet shape (a foil shape, a film shape) like a lithium foil etc. That is, the negative electrode active material layer 30 may be formed by a sheet of a negative electrode active material.

Examples of the electrolyte that can be included in the negative electrode active material layer 30 include the above-described solid electrolytes and electrolytic solutions, and combinations thereof. The conduction agent that can be included in the negative electrode active material layer 30 can be selected as appropriate, for example, from the conduction agents that were given as examples of the conduction agent that can be included in the above-described positive electrode active material layer. The binder that can be included in the negative electrode active material layer 30 can be selected as appropriate, for example, from the binders that were given as examples of the binder that can be included in the above-described positive electrode active material layer. One type each of the electrolyte, the conduction agent, and the binder may be used alone, or two or more types may be used in combination.

### 3.4 Other Components

As shown in FIG. 3, the lithium-ion battery 100 may include the positive electrode current collector 40 that comes into contact with the positive electrode active material layer 10 and the negative electrode current collector 50 that comes into contact with the negative electrode active material layer 30. The configuration of the current collectors itself is commonly known. Other than the above-described components, the lithium-ion battery 100 may include components that are common among batteries. Examples include tabs and terminals. The lithium-ion battery 100 may be a battery in which the above-described components are housed inside an outer casing. For the outer casing, any outer casing that is commonly known as an outer casing of batteries can be adopted. A plurality of batteries 100 may be optionally electrically connected to one another or optionally stacked to constitute a battery pack. In this case, this battery pack may be housed inside a commonly known battery case. Examples of the shape of the lithium-ion battery 100 include a coin shape, a laminate shape, a cylindrical shape, and a rectangular shape. The lithium-ion battery 100 may be a secondary battery.

The lithium-ion battery 100 can be manufactured by applying a commonly known method, except that the above-described specific positive electrode active material is used. For example, the lithium-ion battery 100 can be manufactured as follows:
(1) The positive electrode active material etc. constituting the positive electrode active material layer are dispersed in a solvent to obtain slurry for the positive electrode layer. The solvent used in this case is not particularly limited, and water or various organic solvents can be used. Using a doctor blade etc., the slurry for the positive electrode layer is applied to the surface of the positive electrode current collector and then dried to form a positive electrode active material layer on the surface of the positive electrode current collector. Thus, a positive electrode is produced.
(2) The negative electrode active material etc. constituting the negative electrode active material layer are dispersed in a solvent to obtain slurry for the negative electrode layer. The solvent used in this case is not particularly limited, and water or various organic solvents can be used. Using a doctor blade etc., the slurry for the negative electrode layer is applied to the surface of the negative electrode current collector and then dried to form a negative electrode active material layer on the surface of the negative electrode current collector. Thus, a negative electrode is produced.
(3) The layers are stacked so as to sandwich the electrolyte layer (a solid electrolyte layer or a separator) by the negative electrode and the positive electrode to obtain a stack having the negative electrode current collector, the negative electrode active material layer, the electrolyte layer, the positive electrode active material layer, and the positive electrode current collector in this order. As necessary, other members, such as terminals, are attached to the stack.
(4) The stack is housed in a battery case, and in the case of an electrolytic solution battery, the battery case is filled with an electrolytic solution, and the stack is sealed inside the battery case such that the stack is immersed in the electrolytic solution. Thus, a battery is produced. In the case of an electrolytic solution battery, the negative electrode active material layer, the separator, and the positive electrode active material layer may be soaked with the electrolytic solution at the stage of (3) described above.

In the following, the technology of this disclosure will be described in further detail while showing examples of implementation, but the technology of this disclosure is not limited to the following examples of implementation.

### 1. Production of Positive Electrode Active Material

### 1.1 Example 1

### 1.1.1 Production of Precursor Particles

(1) MnSO₄·5H₂O, NiSO₄·6H₂O, CoSO₄·7H₂O were weighed to an intended composition ratio and dissolved in distilled water to a concentration of 1.2 mol/L to obtain a first solution. In a separate container, Na₂CO₃ was dissolved in distilled water to a concentration of 1.2 mol/L to obtain a second solution.
(2) 1000 mL of pure water was put in a reaction vessel (with a baffle plate), into which 500 mL of the first solution and 500 mL of the second solution were each dripped at a speed of about 4 mL/min.
(3) After the dripping ended, the mixture was stirred at room temperature at a stirring speed of 100 rpm for one hour to obtain a product.
(4) The product was washed with pure water and separated into a solid and a liquid by a centrifugal separator, and a precipitate was collected.
(5) The obtained precipitate was dried overnight at 120° C. and pulverized in a mortar, and was then separated into coarse particles and fine particles by airflow classification. Here, both the coarse particles and the fine particles are composite salt including Mn, Ni, and Co. In Example 1, these coarse particles were used as the precursor particles.

### 1.1.2 Production of Composite Particles

(1) Na₂CO₃ and distilled water were weighed to 1150 g/L and then stirred together using a stirrer until the former is completely dissolved to produce an aqueous solution of Na₂CO₃.
(2) The above-described precursor particles were mixed into the aqueous solution of Na₂CO₃ to obtain slurry. The Na₂CO₃ and the above-described precursor particles were mixed together such that the target composition after firing, to be described later, became Na_{0.7}Mn_{0.4}Ni_{0.2}Co_{0.4}O₂.
(3) The obtained slurry was dried by spray drying. Specifically, using a spray drying device DL410, under the conditions of slurry feed speed: 30 mL/min, inlet temperature:
   200° C., circulation air volume: 0.8 m³/min, and sprayed air pressure: 0.3 MPa, the surfaces of the above-described precursor particles were covered with Na₂CO₃ to 70 area % or more. Thus, composite particles were obtained.

### 1.1.3 Firing of Composite Particles

The composite particles were put in an alumina crucible and firing was performed in an ambient air atmosphere to obtain a Na-containing oxide having the P2-type structure. The firing conditions are the following (1) to (7):
(1) Installing the alumina crucible containing the above-described composite particles in a heating furnace having an ambient air atmosphere.
(2) Raising the temperature inside the heating furnace from room temperature (25° C.) to 600° C. in 115 minutes.
(3) Holding the inside of the heating furnace at 600° C. for 360 minutes to perform preliminary firing.
(4) After the preliminary firing, raising the temperature inside the heating furnace from 600° C. to 800° C. in 60 minutes.
(5) Holding the inside of the heating furnace at 800° C. for 60 minutes to perform main firing.
(6) After the main firing, lowering the temperature inside the heating furnace from 800° C. to 250° C. in 80 minutes.
(7) Taking the alumina crucible out of the heating furnace at 250° C. and letting it cool in a dry atmosphere.

The fired product after being let cool was pulverized using a mortar in a dry atmosphere to obtain Na-containing oxide particles having the P2-type structure.

### 1.1.4 Ion Exchange

(1) LiNO₃ and LiCl were weighed to a molar ratio of 50:50 and mixed with the above-described Na-containing oxide particles to such a molar ratio that the amount of Li became ten times the minimum amount required for ion exchange. Thus, a mixture was obtained.
(2) Using an alumina crucible, ion exchange was performed in an ambient air atmosphere at 280° C. for one hour to obtain a product including Li-containing oxide particles.
(3) Salt remaining in the product was washed with pure water, and the product was separated into a solid and a liquid by vacuum filtration to obtain a precipitate.
(4) The obtained precipitate was dried overnight at 120° C. to obtain Li-containing oxide particles having the O2-type structure.

### 1.1.5 Additional Firing

The obtained Li-containing oxide particles were put in an alumina crucible and fired in an Ar atmosphere at 250° C. for five hours to obtain a positive electrode active material according to Example 1. When checked by an XRD, the positive electrode active material according to Example 1 had the O2-type structure.

### 1.2 Example 2

### 1.2.1 Production of Precursor Particles

Precursor particles were produced in the same manner as in Example 1.

### 1.2.2 Production of Composite Particles

Composite particles were produced in the same manner as in Example 1, except that slurry was obtained by mixing Na₂CO₃ and the above-described precursor particles together such that the target composition after firing became Na_{0.7}Mn_{0.5}Ni_{0.2}Co_{0.3}O₂.

### 1.2.3 Firing of Composite Particles

The composite particles were put in an alumina crucible and firing was performed in an ambient air atmosphere to obtain a Na-containing oxide having the P2-type structure. The firing conditions are the following (1) to (7):
(1) Installing the alumina crucible containing the above-described composite particles in a heating furnace having an ambient air atmosphere.
(2) Raising the temperature inside the heating furnace from room temperature (25° C.) to 600° C. in 115 minutes.
(3) Holding the inside of the heating furnace at 600° C. for 360 minutes to perform preliminary firing.
(4) After the preliminary firing, raising the temperature inside the heating furnace from 600° C. to 900° C. in 100 minutes.
(5) Holding the inside of the heating furnace at 900° C. for 60 minutes to perform main firing.
(6) After the main firing, lowering the temperature inside the heating furnace from 900° C. to 250° C. in 120 minutes.
(7) Taking the alumina crucible out of the heating furnace at 250° C. and letting it cool in a dry atmosphere.

### 1.2.4 Ion Exchange and Additional Firing

After pulverization in a mortar, ion exchange and additional firing were performed in the same manner as in Example 1 to obtain a positive electrode active material according to Example 2. When checked by an XRD, the positive electrode active material according to Example 2 had the O2-type structure.

### 1.3 Example 3

Example 3 is the same as Example 2 until the ion exchange. The Li-containing oxide particles resulting from the ion exchange were put in an alumina crucible and fired in an ambient air atmosphere (air atmosphere) at 250° C. for five hours to obtain a positive electrode active material according to Example 3. When checked by an XRD, the positive electrode active material according to Example 3 had the O2-type structure.

### 1.4 Comparative Example 1

Comparative Example 1 is the same as Examples 2 and 3 except that additional firing was not performed. When checked by an XRD, the positive electrode active material according to Comparative Example 1 had the O2-type structure.

### 1.5 Comparative Examples 2 and 3

A positive electrode active material having the O3-type structure was prepared as a Li-non-deficient positive electrode active material. The positive electrode active material according to Comparative Example 2 is an NCA-based positive electrode active material (LiNi_{0.85}Co_{0.10}Al_{0.05}O₂), and the positive electrode active material according to Comparative Example 3 is an NCM-based positive electrode active material (LiNi_{1/3}Co_{1/3}Mn_{1/3}O₂). The positive electrode active materials according to Comparative Examples 2 and 3 were both obtained by mixing a Li source and a transition metal source together and firing the mixture at a high temperature.

### 2. Determination of Amounts of Impurities Included in Positive Electrode Active Material

For the positive electrode active material of each of Examples 1 to 3 and Comparative Examples 1 to 3, the amount of carbon, the amount of sulfur, the amount of chlorine, and the amount of nitrogen were determined by the following method:
(1) The amount of carbon in a sample was measured by a combustion-infrared absorption method. As a measurement device, a carbon and sulfur analyzer (CS844 type) of LECO JAPAN CORPORATION was used.
(2) The amount of sulfur and the amount of chlorine in the sample were measured by a combustion-ion chromatograph method. As measurement devices, a sample combustion device (AQF-2100S) of Mitsubishi Chemical Analytech Co., Ltd. and an ion chromatograph (Compact IC Flex) of Metrohm Japan Ltd. were used.
(3) The amount of nitrogen in the sample was measured by an inert gas fusion method. As a measurement device, EMGA-920 Type-Ar of HORIBA, Ltd. was used.

### 3. Production of Evaluation Cell

Using each of the above-described positive electrode active materials, an evaluation cell was produced. The production procedure of the evaluation cell is as follows:
(1) The positive electrode active material, a sulfide solid electrolyte (Li₂S—P₂S₅—LiI—LiBr), PVDF, and VGCF were weighed to a ratio (mass ratio) of positive electrode active material:sulfide solid electrolyte:PVDF:VGCF=81.1:15.9:0.6:2.4 and mixed together to obtain a positive electrode composite material. The obtained positive electrode composite material was dispersed in a solvent (butyl butyrate) to obtain positive electrode slurry. The obtained positive electrode slurry was applied to a positive electrode current collector (Al foil) and dried. Then, the positive electrode current collector was pressed by roll pressing under a linear pressure of 100 kN at the pressing temperature shown in Table 1 to form a positive electrode active material layer on the surface of the positive electrode current collector.
(2) A negative electrode active material (lithium titanate), a sulfide solid electrolyte (Li₂S—P₂S₅—LiI—LiBr), PVDF, and VGCF were weighed to a ratio (mass ratio) of negative electrode active material:sulfide solid electrolyte:PVDF:VGCF=72.1:22.7:3.5:1.7 and mixed together to obtain a negative electrode composite material. The obtained negative electrode composite material was dispersed in a solvent (butyl butyrate) to obtain negative electrode slurry. The obtained negative electrode slurry was applied to a negative electrode current collector (Cu foil) and dried. Then, the negative electrode current collector was pressed by roll pressing under a linear pressure of 60 kN at room temperature (25° C.) to form a negative electrode active material layer on the surface of the negative electrode current collector.
(3) A sulfide solid electrolyte (Li₂S—P₂S₅—LiI—LiBr) and acrylate-butadiene rubber (ABR) were weighed to a ratio (mass ratio) of sulfide solid electrolyte:ABR=99.4:0.6 and mixed together to obtain an electrolyte composite material.
(4) The electrolyte composite material was sandwiched between the above-described positive electrode active material layer and the above-described negative electrode active material layer to obtain a stack having the positive electrode current collector, the positive electrode active material layer, the solid electrolyte layer, the negative electrode active material layer, and the negative electrode current collector in this order. The obtained stack was pressed to obtain an evaluation cell (solid battery).

### 4. Evaluation of Charging-Discharging Characteristics

For the evaluation cell of each of Examples 1 to 3 and Comparative Example 1, a two-cycle charging-discharging test was performed at 0.1 C (1 C=220 mA/g) in a constant-temperature bath held at 25° C., in a voltage range of 1.8 to 4.6 V. Then, in the constant-temperature bath held at 25° C., a current corresponding to 3 C was applied for ten seconds in an SOC 50% state (2.35 Vvs. LTO) to measure the DCIR. The measurement result is shown in Table 1 below.

### 5. Evaluation Result

Table 1 below shows, for each of Examples 1 to 3 and Comparative Examples 1 to 3, the crystal structure and the chemical composition of the positive electrode active material, the atmosphere of additional firing after ion exchange, the amounts of impurities (the amount of carbon, the amount of sulfur, the amount of chlorine, and the amount of nitrogen) included in the positive electrode active material, the result of identification of these impurities by an XPS, the position of a peak top of a (002) plane by an XRD, and the measurement result of the resistance of the evaluation cell.

### [Table 1]

TABLE 1

| | | | | | | | | Ratio of | | XRD(°) | |
|---|---|---|---|---|---|---|---|---|---|---|---|
| | Type of positive | | | Impurity | | | | amount of | | 002 | |
| | electrode active material | | Additional | substances (ppm) | | | | carbon/amount | | peak | Resistance |
| | Structure | Chemical composition | firing | C | S | Cl | N | of sulfur | XPS | top | (Ω) |
| Example 1 | O2 | Li0.67 Ni0.16Co0.39Mn0.45O2 | Ar | 180 | 220 | 10 | <500 | 0.82 | Li2CO3 | 18.02 | 14.8 |
| Example 2 | O2 | Li0.61 Ni0.17Co0.29Mn0.54O2 | Ar | 200 | 270 | 10 | <500 | 0.74 | Li2CO3 | 18.17 | 15.7 |
| Example 3 | O2 | Li0.61 Ni0.17Co0.29Mn0.54O2 | Ambient air | 500 | 260 | 10 | <500 | 1.92 | Li2CO3 | 18.19 | 16.0 |
| Comparative | O2 | Li0.61 Ni0.17Co0.29Mn0.54O2 | — | 900 | 260 | 10 | <500 | 3.46 | Li2CO3 | 18.22 | 16.3 |
| Example 1 | | | | | | | | | | | |
| Comparative | O3 | LiNi0.85Co0.10Al0.05O2 | — | 1300 | 1800 | 10 | <500 | 0.72 | Li2CO3 | — | — |
| Example 2 | | | | | | | | | | | |
| Comparative | O3 | LiNi1/3Co1/3Mn1/3O2 | — | 500 | 2000 | 20 | <500 | 0.25 | Li2CO4 | — | — |
| Example 3 | | | | | | | | | | | |

As is clear from the results shown in Table 1, in the positive electrode active material according to Comparative Example 1, the amount of carbon was as large as 900 ppm, which led to high resistance in the evaluation cell. By contrast, in each of the positive electrode active materials according to Examples 1 to 3, the amount of carbon was as small as 500 ppm or less, which led to low resistance in the evaluation cell. It is considered that in the positive electrode active materials according to Examples 1 to 3, the amount of carbon was reduced as a result of decomposition of part of lithium carbonate, which is an impurity, by the additional firing performed on the Li-containing oxide after the ion exchange (FIG. 2). When Comparative Example 1 and Examples 1 to 3 are compared, there is a shift in the peak top of the 002 plane in the X-ray diffraction pattern. A possible explanation is that lithium resulting from decomposition of lithium carbonate, which is an impurity, was taken into the O2-type structure and caused a change in the c-axis length. Such decomposition and removal of impurities by additional firing is peculiar to a positive electrode active material having the O2-type structure that is a Li-deficient structure.

In the positive electrode active material according to Comparative Example 2, the amount of carbon and the amount of sulfur were both large. In the positive electrode active material according to Comparative Example 3, while the amount of carbon is small, the amount of sulfur was large. The positive electrode active materials according to Comparative Examples 2 and 3 have a Li-non-deficient O3-type structure, and even if additional firing is performed, reducing the amount of carbon would be difficult.

### 6. Supplementary Description

In the above-described Examples, the case where the precursor particles are obtained by the coprecipitation method has been illustrated, but the precursor particles can also be obtained by other methods. In the above-described Examples, the case where the composite particles are obtained by mixing the precursor particles and the Na₂CO₃ solution together has been illustrated, but the composite particles can also be obtained by other methods. In the above-described Examples, as the Na-containing oxide having the P2-type structure and the Li-containing oxide having the O2-type structure, those having the predetermined chemical compositions have been illustrated, but the chemical compositions of the Na-containing oxide and the Li-containing oxide are not limited thereto. For example, in the Na-containing oxide and the Li-containing oxide, an element M other than Mn, Ni, and Co may be doped. The element M is as has been described in the embodiment.

What is claimed is:

1. A positive electrode active material having an O2-type structure, wherein the positive electrode active material has an amount of carbon of 500 ppm or less.

2. The positive electrode active material according to claim 1, wherein the positive electrode active material has an amount of sulfur of 300 ppm or less.

3. A lithium-ion battery, comprising a positive electrode active material layer, an electrolyte layer, and a negative electrode active material layer, wherein the positive electrode active material layer includes the positive electrode active material according to claim 1.

4. A manufacturing method of a positive electrode active material, comprising:
exchanging at least some of Na ions of a Na-containing oxide having a P2-type structure with Li ions to obtain a Li-containing oxide having an O2-type structure; and
heating the Li-containing oxide to reduce an amount of carbon in the Li-containing oxide.

5. The manufacturing method of a positive electrode active material according to claim 4, wherein:
an atmosphere in which the Li-containing oxide is heated is an inert gas atmosphere or an oxygen-containing atmosphere; and
a temperature at which the Li-containing oxide is heated is 200° C. or higher and 300° C. or lower.

6. The manufacturing method of a positive electrode active material according to claim 4, wherein the Li-containing oxide is washed with water to reduce an amount of sulfur in the Li-containing oxide.
